(19) United States
(12) Patent Application Publication
(10) Pub. No.: US 2010/0006393 A1
(43) Pub. Date: Jan. 14, 2010

(54) Diverter Assembly

(75) Inventor: Donald L. LeCroy, Mableton, GA (US)

Correspondence Address: DICKINSON WRIGHT PLLC, 1875 Eye Street, NW, Suite 1200, WASHINGTON, DC, 20006, US

(73) Assignee: JERVIS B. WEBB COMPANY, Farmington Hills, MI (US)

(21) Appl. No.: 12/172,357

(22) Filed: Jul. 14, 2008

(51) Int. Cl. B65G 47/46

(52) U.S. Cl. 198/370.02

(57) ABSTRACT

A diverter assembly for conveyor systems that moves in a substantially linear direction in and out of the path of loads on the conveyor system.

### TECHNICAL FIELD

The present invention is directed to a conveyor system and more particularly to a diverter assembly for sorting loads on a conveyor system.

### BACKGROUND OF THE INVENTION

Conveyor systems are widely used in a variety of industries, such as in shipping and baggage handling industries, for automatically sorting loads between various destinations. The most common method of sorting loads between different destinations is to use a diverter or a pusher assembly to divert loads from the current conveyor segment to a specific adjacent or branch conveyor segment.

As package delivery companies, shipping companies, fulfillment warehouses, and baggage sorting systems sort an increasing number of loads for delivery to a variety of locations, companies are turning to automated conveyor transfer systems that automatically direct the load to the proper destination. Many of these systems use bar codes or the like to read the destination of the package and then respond accordingly. In order to increase the sortation rate of the conveyor system, the speed of travel of a load along a particular conveyor segment is generally increased, requiring the diverter assembly to move quickly between a position capable of allowing the passage of the loads and a position capable of moving the loads to another conveyor segment.

Some conveyor systems use a mechanical pusher arm, such as a flat plate, that pushes the load perpendicular to the direction of travel on the current conveyor segment. The problem with these pusher arms is that it is difficult to correctly time when the load should be pushed onto a branch conveyor segment and any mistakes in timing may cause errors such as causing the system to jam or the load to be incorrectly displaced or not displaced, such that the load is traveling on the wrong conveyor segment. In addition, the amount of force to push a load perpendicular to the current direction of travel is high, and therefore, in some circumstances, the load may become damaged or the outer surface of the package, in particular loads that have aesthetic outer surfaces such as baggage or luggage, may become damaged.

To solve many of the above problems with perpendicular pusher arms, many conveyor systems use diverters that are angled relative to the path of travel of the load and pivot in and out of the path of the load. These angled pusher assemblies form an angled abutment surface onto which the load impacts the downstream end of the angled diverter. This diverting action relies on the forward momentum of the load and may also use a belt on the diverter assembly to assist in moving the load to an adjacent conveyor segment. A typical diverter assembly moves between two positions. In one position, the diverter body is in the path of the loads on the current conveyor segment, and in the other position the diverter body is out of the path of the loads on the current conveyor segment.

As the speed of a conveyor system increases, and in particular, the speed of the loads, the force of impact by the load on the diverter assembly increases. Therefore, generally the sortation rate and the force of impact on the diverter assembly are proportional. Any increase in speed of the conveyor system also increases stress on the diverter assembly over time. To move the diverter assembly quickly between positions, it is helpful for the assembly to be lightweight; however, to continually withstand the force of impacts of loads over time, it is helpful for the diverter assembly to be robust and of a heavier weight. While designers of conveyor systems attempt to balance these competing needs, most pivoting diverter assemblies over time experience significant stress, in particular, metal fatigue. Areas of concern include the axis about which the diverter assembly pivots, the pivot connection between the diverter body and the mechanism for pivoting the diverter body, and in some embodiments, the pivoting axis that connects the mechanism for pivoting the diverter body to the frame of the conveyor system. As many of the loads are time-sensitive, it is desirable to minimize any down time.

One particular point of failure for diverter assemblies is the pivot coupling between the arm that pivots the diverter into place and the main diverter body itself. This coupling must be free to pivot, but also receives a majority of the force of the load impacting the diverter body. Many times this coupling is a pin or bolt that allows the necessary pivoting motion. Over time, it is common for this pin to break. While the system may be designed to easily replace the pin, such a failure many times causes loads to jam during operation, loads to reach the wrong destination, and in some circumstances may be difficult to access for repair. Therefore, it is desirable to have a robust diverter assembly that minimizes downtime of the system through a design that reduces stress to the system.

### SUMMARY OF THE INVENTION

The present invention is directed toward a conveyor system and more particularly to a diverter assembly for sorting loads on a conveyor system.

The conveyor system generally includes a junction where the incoming loads may be split into at least two directions or onto at least two conveyor segments. The diverter is used to sort the loads between the two directions or segments by allowing in a free position the load to pass uninterrupted or in a blocking position blocking the path of the load such that the load is forced onto an adjacent conveyor segment. The diverter uses two posts, one on each side of the conveyor as structural support. The diverter is coupled to the post and travels between the blocking position and the free position along the longitudinal axis of the post. As the posts are generally stationary, the diverter is fixed from angular movement or movement that angles the face of the diverter across the conveyor segment relative to the path of the incoming loads.

In some embodiments, the diverter may rotate about a diverter body axis while maintaining its angularly fixed position between the two posts relative to the path of the incoming loads. More specifically, in some situations where a low profile diverter is needed, the diverter body rotates about its axis to allow loads to pass freely while minimizing the space required for the diverter to reach such a position.

Further scope and applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a schematic top view of an exemplary conveyor system having multiple diverter assemblies;

FIG. 2 is a top view of an exemplary conveyor system with a 45° below the belt diverter with a strip belt center in a transition take-away plate;

FIG. 3 is a top view of an exemplary conveyor system with a 45° above the belt diverter and a strip belt take-away;

FIG. 4 is a top view of an exemplary conveyor system with a 45° above the belt diverter and a make-up pier;

FIG. 5 is a top view of an exemplary conveyor system with a 45° below the belt diverter with a center roller bed and a make-up pier;

FIG. 6 is a partial front view of an above the belt diverter in a lower position;

FIG. 7 is a partial front view of an above the belt diverter in a raised position;

FIG. 8 is a partial front view of an above the belt diverter in an extended raised position;

FIG. 9 is a partial front view of a below the belt diverter in a lower position;

FIG. 10 is a partial front view of a below the belt diverter in a raised position;

FIG. 11 is a partial front view of an above the belt diverter in a lower position;

FIG. 12 is a partial front view of the above the belt diverter of FIG. 11 in a raised position;

FIG. 13 is a schematic illustration of an exemplary low clearance above the belt diverter; and

FIG. 14 is a second schematic illustration of an exemplary low clearance above the belt diverter.

### DETAILED DESCRIPTION OF THE PREFERRED EMBODIMENT

A conveyor system 10 having a sorting system 30 further including a diverter assembly 70 is illustrated and described with reference to the Figures. It should be appreciated that the diverter assembly 70 may be used with a variety of conveyor configurations and that the illustrated conveyor system 10 and sorting assembly 30 are only exemplary configurations. For example, the conveyor system 10 may have a variety of different downstream conveyor segments.

The conveyor system 10 may be any system capable of transporting a load (not illustrated) to a destination. The conveyor system 10 will have at least two destinations which will require the sorting assembly 30, more particularly diverter assembly 70, to separate and sort the loads such that they reach the desired destinations. Any conveyor system capable of carrying a load to a destination may use the diverter assembly 70. In the illustrated embodiments, the conveyor system 10 includes a frame 12 supporting a load surface 14 such as a belt surface or bed 15 or rollers 16. Of course, other conveyor assemblies may have different load bearing surfaces.

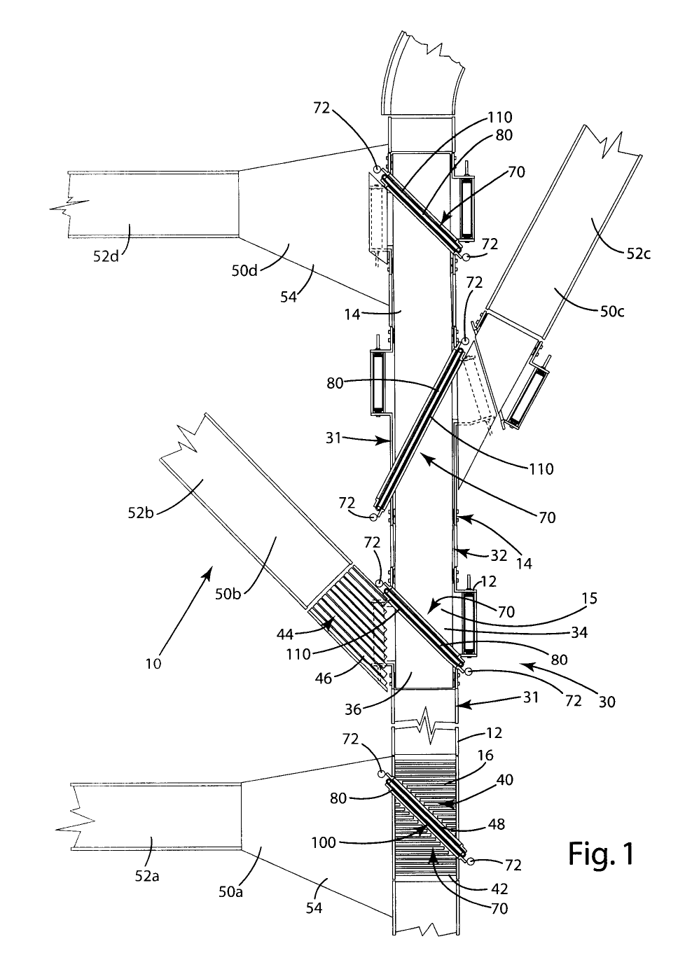

The sorting assembly 30 as illustrated in FIG. 1 generally includes a primary conveyor segment 31 and at least one adjacent conveyor 50 segment. The adjacent conveyor segment 50 may also be referred to as a branch conveyor segment. Although FIG. 1 illustrates the sorting assembly 30 as having a plurality of branch segments 50A-D, the present invention may be applicable to a conveyor system with only a one branch segment. The number of branch segments is irrelevant to the present invention, as each branch segment will generally require a diverter assembly. Each branch segment may also have additional downstream diverter assemblies further creating sub-branch assemblies (not illustrated). For many sorting conveyor systems, the loads are initially sorted into major groups and then each group is further sorted into sub-groups. As an example, for an airport baggage handling system, the baggage may be initially sorted by international and domestic destinations, then further sorted by large geographic areas within such international or domestic locations, and again further sorted by city destination or a flight number to a particular city destination.

As illustrated in the Figures, the sorting assembly 30 and in particular, the primary conveyor segment 31, includes a main belt 32. As long as each diverter assembly 70 is an above-the-belt diverter assembly, the belt or other load-conveying surface 32 may extend for the length of the primary conveyor segment 31. However, as illustrated in FIG. 1, some diverter assemblies 70 may be below-the-belt diverter assemblies, such that the load will pass over a portion of the diverter assembly 70, instead of under a portion of the diverter assembly 70. Therefore, as illustrated in FIG. 1, the primary conveyor segment 31 may be broken into smaller diverter segment belts 34, roller beds 40, and strip conveyors 44. The actual mechanism for moving the load between its origin and destination is irrelevant to the present invention, as any type of system for conveying the load along the conveyor system 10 may be used. If a roller bed 40 is used, it includes rollers 42 which support and transport the load. If a strip conveyor 44 is used, it includes strip belts 46 which support and convey the load. Where the diverter assembly 70 is a below-the-belt diverter assembly, the primary conveyor segment 31 may include a split 48 in the load surface 14, thereby allowing the diverter assembly to be located under the bed 15 to allow the load to pass over, instead of impeding the load from traveling along the primary conveyor segment 31.

The sorting assembly 30 may further include the branch conveyor segments 50A-D as illustrated in FIG. 1. These branch conveyor segments 50A-D may include a variety of load transportation systems, but are for ease of illustration primarily illustrated with downstream belts 52A-D. Of course in some embodiments, the system uses a pier 54 to collect and move the loads that are diverted off the primary conveyor segment 31.

Although not illustrated, the conveyor system 10, and in particular the sorting assembly 30, may include at least one upstream metering conveyor which allows the conveyor system 10 to space the loads sufficiently apart to permit the diverter assembly 70 to function. Therefore, as the sorting assembly 30 receives loads from the metering conveyors in a controlled fashion, it is capable of sorting the loads to the various branch conveyor segments 50A-D.

The loads can be a wide variety of articles such as parcels, baggage, or goods. One skilled in the art will recognize that the conveyor system 10 is only exemplarily described above and illustrated in the Figures with only the major parts of the conveyor system that are necessary to understand that the operation and location of the diverter assembly 70. One skilled in the art will recognize that a multitude of other parts form the conveyor system 10, such as motors, belts, chains, supporting structures, and any other items needed to allow the conveyor system 10 to function.

The diverter assembly 70 is illustrated in the Figures and generally includes at least two posts 72 solidly anchored to prevent movement of the diverter assembly 70 during impacts from loads. It is expected that the diverter assembly 70 will be anchored through the posts 72 to the frame 12 of the conveyor system 10, or in some embodiments anchored directly to the supporting surface that also supports the frame 12 of the conveyor system 10.

The diverter assembly 70 further includes a main diverter body 80. The main diverter body 80 may have any size, shape, or configuration, but is generally a flat body having a longitudinal extent 86 extending between the post 72. The diverter body 80 also includes a lateral extent 88, which helps provide a large surface area to minimize the effects on the loads and impacts and provides a sufficient area to support the moveable belt, if so equipped. As further illustrated in FIG. 15, the diverter body 80 may further include cavities 84 for receiving the post 72. Also, linear bearings, such as bushings 82, may be located between the post 72 and cavities 84 to allow the diverter body 80 to slide up and down on the post 72, along the post is longitudinal axis 76. Although not illustrated, the diverter assembly 70 may further include a diverter belt 92, as well as mechanisms for moving the diverter belt to assist in transferring the load from the current conveyor segment to an adjacent conveyor segment 50.

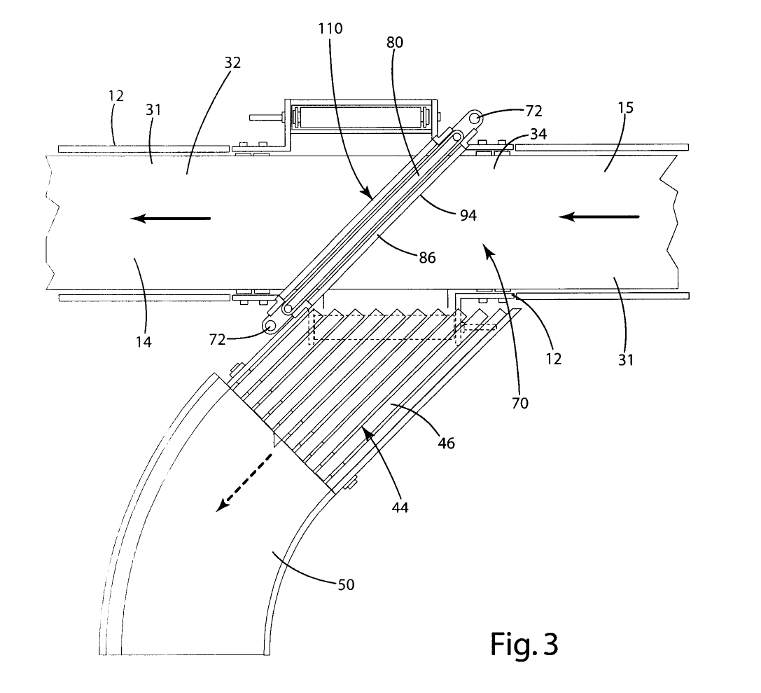

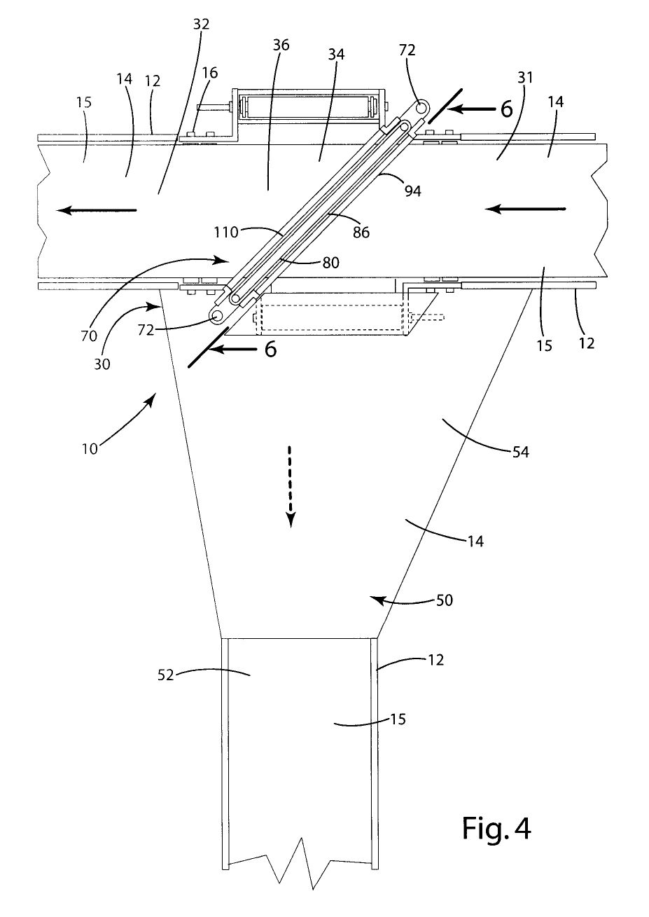

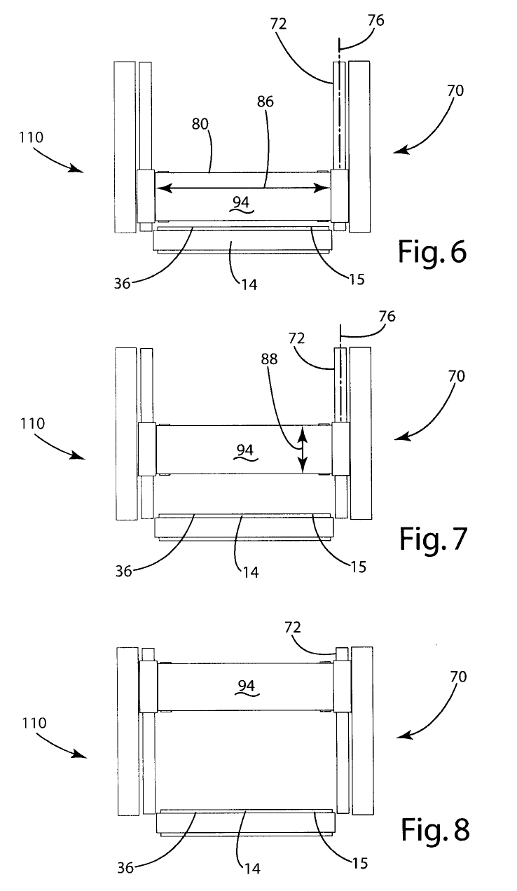

As illustrated in the Figures, the diverter assembly 70 may include a diverter body 80 that is stored below the load surface 14 or above the load surface with sufficient clearance to allow a load to pass underneath when it is in a position to allow the load to continue on the current conveyor segment unimpeded. More specifically, as illustrated in FIGS. 1, 3-4 and 6-8, an above-the-belt diverter 110 allows the load to pass under when the load is to remain on the primary conveyor segment 31. As further illustrated in FIGS. 6-8, when it is desirable for the load to be blocked by the above-the-belt diverter 110 and thereby prevent further travel of the load along the primary conveyor segment 31, and instead divert the load to an adjacent conveyor segment 50, the above-the-belt diverter is located in the lower position as illustrated in FIG. 6. When it is desirable for the load to continue unimpeded on the current conveyor segment, the above-the-belt diverter is raised to a first position such as in FIG. 7, thereby allowing most loads to pass by. In certain embodiments where taller loads, such as in baggage handling systems for airports, only infrequently travel down the conveyor system, the diverter assembly may have an extended raised position as illustrated in FIG. 8. This allows the higher than normal loads to pass under the diverter assembly 70, in particular, the diverter body 80 when desired. Although illustrated in the Figures, it is not desirable to put the diverter assembly in the extended raised position each and every time the diverter body 80 is raised, as it takes additional time to cycle between the extended raised position and the lower position. In comparison the system may cycle faster between the raised position illustrated in FIG. 7 and the lower position. Faster cycle times are important to allow for quicker sorting of loads.

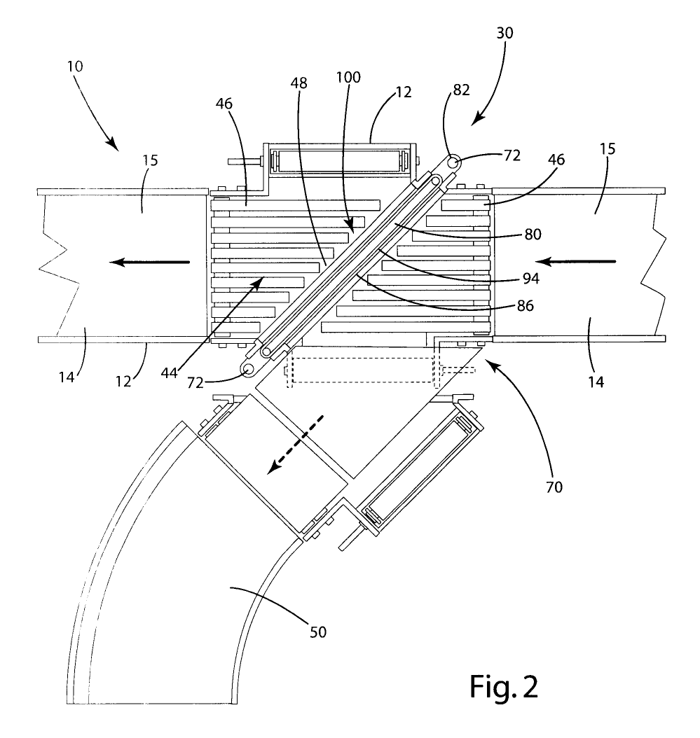

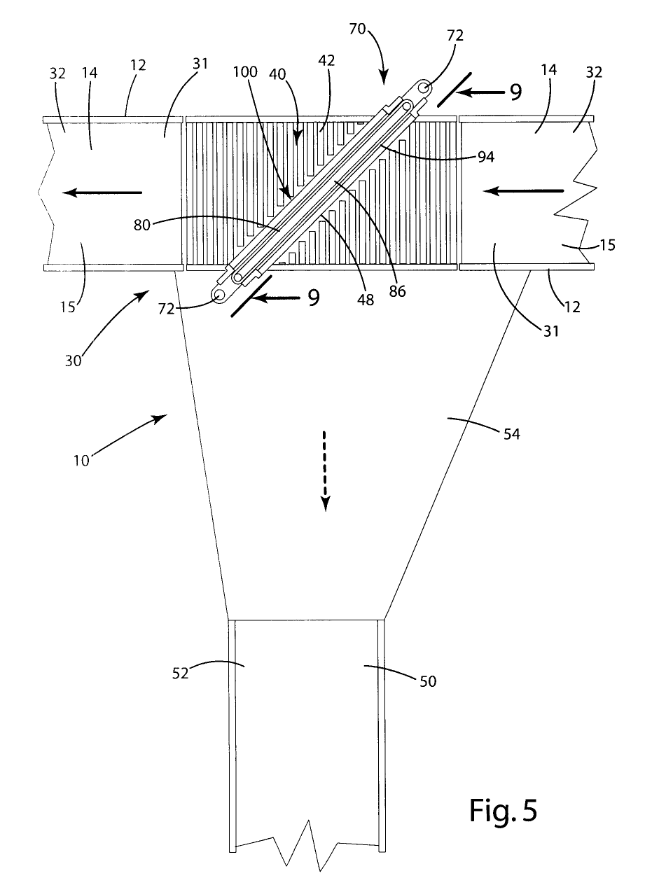

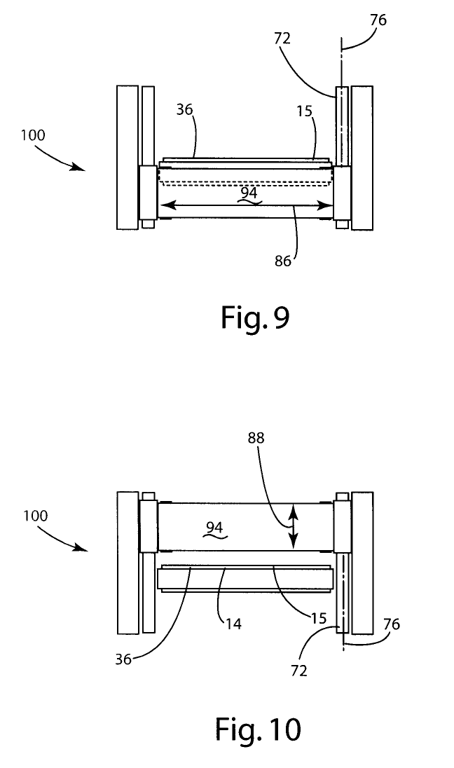

As also illustrated in FIGS. 1, 2, 5 and 9-10, the diverter assembly may be a below-the-belt diverter 100 which is stored in the lower position within a split 48 in the bed 14 which allows a load to pass over the diverter body 80, as illustrated in FIG. 9. While a below-the-belt diverter 100, as illustrated in FIGS. 2 and 5, requires the split in the bed and thereby requires a strip conveyor 44, a roller bed 40, or other mechanisms to accommodate for the split, the below-the-belt diverter allows for a lower profile and eliminates the need to worry about the height of a particular load. As illustrated in FIG. 10, the below-the-belt diverter 100 has a raised position blocking a load from passing, thereby transferring the load to an adjacent conveyor segment 50.

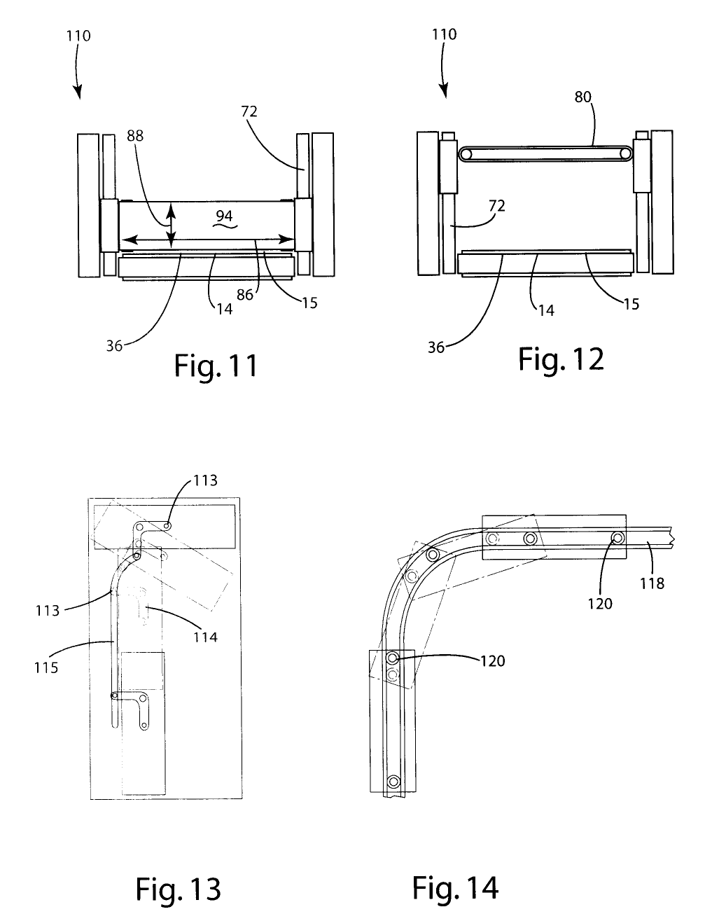

Some diverter assemblies, where it is desired to have the above-the-belt diverter for structural considerations, may only have a limited clearance above the conveyor bed. To accommodate the passage of loads, the above-the-belt diverter may include a diverter body 80, such as the rotating diverter body 112 illustrated in FIGS. 11 and 12. FIG. 11 shows the lower position of a rotating or track diverter 112 or 116, and FIG. 12 shows the upper position of the rotation or track diverter 112 or 116. FIG. 13 specifically shows the motion of the diverter body 80, specifically a rotating diverter 112, as it is raised. The lower and upper positions are shown in solid lines in FIG. 13, with phantom lines showing movement of the diverter body 80 between the two positions. More specifically, as the diverter body 80 is raised to accommodate for the passage of a load, the rotating diverter portion 112 also pivots or rotates about its longitudinal extent as it is raised to go from an impact surface 94, which is aligned between the two posts and substantially with the post longitudinal axis to a position that is substantially out of alignment with the two posts 72. Another low clearance diverter is a track diverter 116 which raises along a track 118 similar to a garage door. The track diverter as it is raised also extends away from the post 72. In addition, the track diverter 116 requires the track 118 to extend away from the post 72.

During operation, the diverter assembly 70 is in a position to either block the passage of loads or allow for the passage of loads along the primary conveyor segment 31. Given the arrangement of the diverter body 80 about the post 72, a large, sturdy connection is made, thereby minimizing breakdowns due to metal fatigue and other stress. The force is carried by a large post instead of a small pin area. Thereby the diverter assembly 70 as described above provides a robust assembly that minimizes the potential for breakdowns. The control of the diverter is similar to and pivoting diverters currently available in the industry, except that the mechanism for moving the diverter extends and retracts the diverter along the longitudinal axis of the poles.

The diverter body 80 is attached to the two vertical posts 72 in one embodiment by linear bearings (not shown) that provide a low friction but rigid attachment between the diverter body and posts. The linear bearing assemblies are then connected to mobile attachment points of high speed linear actuators (not shown). The linear actuators may be any device that move the diverter body along the longitudinal axis of the post. In some embodiments, one linear high-speed linear actuator may be used and in other embodiments, at least a pair of high speed linear actuators may be used to move the diverter body along the longitudinal axis of the post. For example, where a pair of linear actuators are attached, one may be attached proximate to each longitudinal post. In another example where one linear actuator is used, such as for a below-the-belt diverter, a single centrally located linear actuator may be placed underneath the conveyor belt that moves the diverter body up and through the conveyor system while maintaining its central attachment. The actuators raise and lower the diverter body as directed by the system controls. If a pair of actuators is used, the actuators should be synchronized to ensure independent but simultaneous movement. The other option for controlling a pair of actuators is to have the actuators mechanically connected or activated by a single power source. Exemplary linear actuators may include linear motors, step motors, server motors. The actuators may be coupled to the diverter body through belt, gear or chain drives such as a pulley being mounted on each of the actuator profile with one pulley acting as a driver gear and the other as a driven gear to move the diverter body between its various positions. In some embodiments, the actuator may also be coupled to the diverter body through a ball screw or magnetic driven low friction drive.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

1. A diverter assembly for a conveyor system comprising:
a pair of posts having a longitudinal axis; and
a diverter coupled to said posts and capable of travel along said longitudinal axis.

2. The diverter assembly of claim 1 further comprising at least two cavities, each of said cavities receiving one of said pair of posts.

3. The diverter assembly of claim 2 wherein said diverter includes a longitudinal extent extending between said posts and a moveable diverter belt extending along said longitudinal extent.

4. The diverter assembly of claim 3 wherein said diverter includes at least two sides and said belt extends in a continuous loop about both sides.

5. The diverter assembly of claim 4 further including a diverter motor for driving said belt.

6. The diverter assembly of claim 5 further including a track attached to said posts and wherein said diverter is coupled to said track.

7. The diverter assembly of claim 1 wherein said diverter has a lower position and an upper position and said diverter includes a longitudinal extent extending between said posts and wherein said longitudinal extent is rotated in said upper position, relative to said longitudinal extent in said lower position.

8. The diverter assembly of claim 1 wherein said diverter includes a front face having a planar surface and wherein said front face is approximately aligned with said longitudinal axis of said posts in a lower position and substantially not in alignment with said longitudinal axis of said posts in an upper position.

9. The diverter assembly of claim 1 wherein said diverter includes a front face having a planar surface and wherein said front face is approximately aligned with said longitudinal axis of said posts in a lower position and is pivoted out of said alignment with said longitudinal axis in an upper position.

10. The diverter assembly of claim 9 wherein said diverter includes a center of gravity and wherein said center of gravity is approximately aligned with and between said posts.

11. The diverter assembly of claim 9 wherein said diverter includes a center of gravity and wherein said center of gravity is approximately aligned between said posts in said lower position and wherein said center of gravity is displaced outward from said posts in said upper position.

12. The diverter assembly of claim 1 further including a linear actuator coupled to said diverter between said pair of posts.

13. The diverter assembly of claim 1 further including a pair of actuators, coupled to said diverter proximate to said pair of posts.

14. A conveyor system comprising:
a substantially planar load support surface; and
a diverter having a longitudinal extent extending across said conveyor system and wherein said diverter is fixed from arcuate movement across the surface of said planar load support surface.

15. The conveyor system of claim 14 wherein said diverter in a lower position is equal to or below said planar load support surface and in an upper position is at least partially above said planar load support surface.

16. The conveyor system of claim 15 wherein said conveyor system includes a frame defining a slot in said load support surface.

17. The conveyor system of claim 16 wherein said diverter is located within said slot in said lower position.

18. The conveyor system of claim 15 wherein said load support surface includes at least one of a roller bed or a strip conveyor.

19. The conveyor system of claim 18 wherein said load support surface is a roller bed including a plurality of rollers and wherein said rollers include at least three different lengths.

20. The conveyor system of claim 14 wherein said diverter includes a center of gravity and wherein during operation said center of gravity is moved vertically relative to said planar load support surface.

21. The conveyor system of claim 14 wherein the movement of said diverter during operation is approximately perpendicular for the majority of said movement.

22. The conveyor system of claim 14 wherein said diverter is free from actuation mechanisms extending across at least part of said load support surface and free from actuation mechanisms pivotally coupled to said diverter near the center of said diverter.

23. The diverter of claim 14 further including a pair of posts each having a longitudinal axis and a linear actuator that operates substantially parallel to said longitudinal axes.

24. A conveyor system comprising:
a frame supporting a load handling system and wherein said load handling system includes a load support surface and wherein said load handling system includes at least an upstream conveyor segment and at least two downstream conveyor segments meeting at a load junction;
a diverter located at said load junction and capable of diverting loads to at least one of said two downstream segments and wherein said upstream conveyor segment includes a width and an upstream longitudinal axis and wherein said diverter substantially extends across said width and is substantially fixed from moving angularly relative to said longitudinal axis across said width, and wherein said diverter moves substantially perpendicular to said load surface.

25. (canceled)

26. The conveyor system of claim 24 wherein said conveyor segments move the loads in a substantially horizontal plane and wherein the majority of movement by said diverter is in a substantially vertical direction relative to said horizontal plane.

27. The conveyor system of claim 24 wherein said frame defines a space opening across said load surface for receiving said diverter in a lower position.

28. The conveyor system of claim 27 wherein said diverter in said lower position allows loads to pass said longitudinal axis of said upstream conveyor segment.

29. The conveyor system of claim 27 wherein said diverter in a raised position diverts loads from said longitudinal axis of said upstream conveyor segment.

30. The conveyor system of claim 24 wherein said diverter in a lower position diverts loads from said longitudinal axis of said upstream conveyor segment.

31. The conveyor system of claim 24 wherein said diverter in an upper position allows loads to continue along said longitudinal axis of said upstream conveyor segment.

32. A diverter assembly for a conveyor system comprising:
a pair of posts; and
a diverter coupled to said posts and moveable along said posts and wherein said diverter has a lower position and an upper position and said diverter includes a longitudinal extent and wherein said longitudinal extent is rotated in said upper position, relative to said longitudinal extent in said lower position.
